(19) United States
(12) Patent Application Publication
(10) Pub. No.: US 2013/0189957 A1
(43) Pub. Date: Jul. 25, 2013

(54) COMPUTERIZED SYSTEM ARCHITECTURE FOR MONITORING USAGE OF TELECOMMUNICATION DEVICES AND METHOD OF USE

(71) Applicant: KOHORTS IT SERVICES, LLC, Brighton, MI (US)

(72) Inventors: J. Robert Kamal, Brighton, MI (US); Peter Bainbridge-Clayton, Mark Cross (GB)

(73) Assignee: KOHORTS IT SERVICES, LLC, Brighton, MI (US)

(21) Appl. No.: 13/740,882

(22) Filed: Jan. 14, 2013

Related U.S. Application Data
(60) Provisional application No. 61/586,488, filed on Jan. 13, 2012.

(51) Int. Cl. H04W 8/18

(52) U.S. Cl. CPC H04W 8/18
USPC 455/412.1; 455/418

(57) ABSTRACT

A computerized system for controlling the behavior of a telecommunications device includes a server computer in communication with the telecommunications device, the server computer configured to download a software application to the telecommunications device, the software application configured to capture messages and transactional data, and transmit the messages and transactional data to the server computer, the software application including a plurality of controller modules in communication with a plurality of subsystems on the telecommunications device, wherein each of the plurality of subsystems manage and execute at least one function of the telecommunications device; a configuration script in communication with the controller modules, the configuration script being configured to control the functionality of the software application and the telecommunication device; and a communications block configured to enable communication between the telecommunications device and the server computer.

### CROSS REFERENCE TO RELATED APPLICATION

This application claims the benefit of provisional patent application No. 61/586,488, filed Jan. 13, 2012, which is hereby incorporated by reference.

### BACKGROUND

1. Field of the Invention

The subject disclosure generally relates to a system architecture and method for monitoring information on a telecommunications device.

2. Description of the Related Art

Telecommunications devices, such as cell phones, smart phones, or tablets have become commonplace and often necessary fixtures of everyday life. Often these devices are issued by employers to employees for use in carrying on business or to children by parents. As such, monitoring of the usage of such devices is often necessary to ensure that the devices are not being misused and/or to ensure the safety of the user. However, comprehensive monitoring of telecommunications devices, as well as assembling data relating to such monitoring, remains a challenge. Furthermore, the second party to conversations with monitored devices may not be aware that such monitoring is taking place.

Accordingly, the subject application discloses a computerized system and method for addressing these difficulties.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a block diagram showing one embodiment of a computerized system for monitoring and recording information on telecommunication devices.

FIG. 2 is a block diagram showing schematic architecture of a software application of the computerized system.

FIG. 3 is a display view of a web browser showing a usage statistics graph for a first telecommunication device.

FIG. 4 is a display view of the web browser showing detailed usage logs for the first telecommunication device.

### DETAILED DESCRIPTION

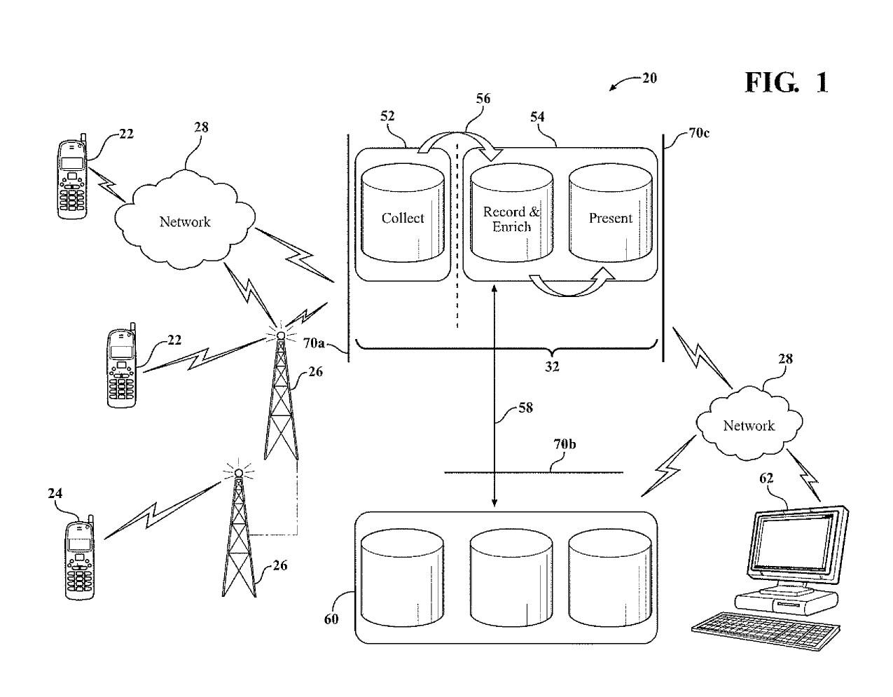

With reference to the Figures, wherein like numerals indicate like or corresponding parts throughout the several views, a computerized system 20 a computerized system for dynamically controlling the behaviour of a telecommunications device in response to various telecommunications related, chronological, positional, environmental and other events and scenarios, and combinations thereof is generally shown in FIG. 1. Additionally, a method for monitoring and recording data and usage statistics of the data sent to and from the telecommunication devices is described herein.

The computerized system 20 includes a first telecommunication device 22 and a second telecommunication device 24 capable of communicating with the first telecommunication device 22. It is to be appreciated that the system 20 may include a plurality of first telecommunication devices and/or a plurality of second telecommunication devices 22, 24. However, in the interest simplicity and readability, the computerized system 20 of the present disclosure will be discussed with regard to a single first telecommunication device 22 and a single second telecommunication device 24.

The first and second telecommunication devices 22, 24 are typically capable of sending and/or receiving audible conversations and/or character-based messages. The term “audible conversations” include, but is not limited to, common and ubiquitous telephone conversations. The term “character-based messages” includes, but is not limited to, text messages utilizing short message service (SMS) and messages having multimedia content, such as pictures or video, utilizing multimedia messaging service (MMS).

The first and second telecommunication devices 22, 24 are preferably mobile phones. The mobile phones are often referred to as cellular phones, cell phones, smartphones, wireless phones, or any other suitable terms as used in the art. Alternatively, the first and second telecommunication devices 22, 24 may also include other devices, such as, but not limited to, pagers, landline phones, personal computers, laptop computers, tablet computers, electronic reading devices (e-readers), or any other device capable of sending and/or receiving audible conversations and/or character-based messages.

Preferably, the first and second telecommunication devices 22, 24 each have computing capabilities. Specifically, the first and second telecommunication devices 22, 24 each include a processor (not shown). The processor may be a microprocessor, microcontroller, application specific integrated circuit (ASIC) or other device capable of performing numerical calculations and execute software programs as is known in the art. The processor may run an operating system specific to the telecommunication device. Some suitable telecommunication devices include, but are not limited to, BlackBerry® smartphones manufactured by Research In Motion Ltd. of Waterloo, Ontario, Canada, and iPhone® smartphones manufactured by Apple Inc. of Cupertino, Calif. and Android® devices. BlackBerry® smartphones typically run BlackBerry OS operating system and iPhone® smartphones typically run iOS operating system. The BlackBerry OS operation system is substantially different than the iOS operating system such that many programs designed for the BlackBerry OS will not operate on the iOS and vice versa.

The first and second telecommunication devices 22, 24 may operate on a mobile phone network 26. The mobile phone network 26 is often referred to as a cellular phone network, cell phone network, or a telecommunication network, as known in the art. The first and second telecommunication devices 22, 24 and the mobile phone network 26 may utilize any analog and/or digital cellular technology, including, but not limited to, GSM, GPRS, CDMA, EV-DO, EDGE, 3GSM, DECT, TDMA, and iDEN.

Alternatively, the first and second telecommunication devices 22, 24 may communicate via a network 28 such as the Internet. For example, the first and second telecommunication devices 22, 24 may be IP phones or mobile phones having WiFi connectivity. Of course, it is to be appreciated that other techniques for facilitating communications between the first telecommunication device 22 and the second telecommunication device 24 may be employed without deviating from the scope of the present disclosure.

A software application 30 is loaded on to the first telecommunication device 22 for configuring the device 22 for use with the computerized system 20. The software application 30 is typically sent from a server computer 32 on a central server to the first telecommunication device 22. The software application 30 is typically loaded onto the first telecommunication device 22 via over-the-air (OTA) techniques. In other words, the software application 30 may be loaded on to the first telecommunication device 22 through the mobile phone network 26 or other network 28, without having to physically connect the first telecommunication device 22 to another piece of equipment. However, it is to be appreciated that other techniques for loading the software application 30 onto the first telecommunication device 22 may be employed without deviating from the scope of the present disclosure. In addition, the software application 30 may be modified or reconfigured dynamically by commands or instructions sent from the server computer 32.

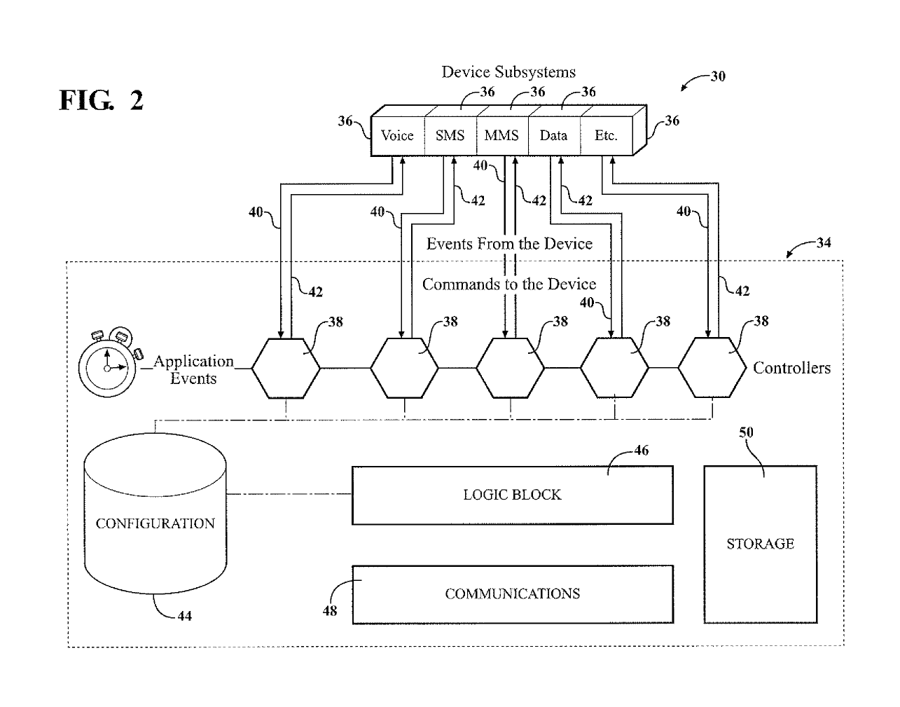

With additional reference to the FIG. 2, an architecture 34 of the software application 30 is illustrated. Each of the telecommunication devices 22, 24 include a plurality of subsystems 36. The subsystems 36 each manage and execute at least one function on the telecommunication devices 22, 24. The subsystems 36 typically include, but are not limited to: a voice subsystem, a data subsystem, an email subsystem, a Wi-Fi subsystem, a SMS subsystem, a MMS subsystem, a global positioning system (GPS) subsystem, and a device power subsystem. It is to be appreciated that any or all of the subsystems 36 may be incorporated into each of the telecommunication devices 22, 24. It is to be further appreciated that additional subsystems 36 may also be utilized without deviating from the scope of the present disclosure.

The software application 30 comprises a plurality of controller modules 38. The controller modules 38 are in communication with the subsystems 36. More specifically, one of the controller modules 38 is linked to one of the subsystems 36 on the first telecommunication device 22. Accordingly, the controller modules 38 typically include, but are not limited to: a voice controller, a data controller, an email controller, a Wi-Fi controller, a SMS controller, a MMS controller, a GPS controller, and a device power controller. For example, the voice controller is typically linked to the voice subsystem, the SMS controller is typically linked to the SMS subsystem, etc. It is to be appreciated that additional controller modules 38 may also be incorporated into the software application 30 without deviating from the scope of the present disclosure. Additionally, the controller modules 38 may send commands from the software application 30 to the first telecommunication device 22 for controlling the device 22. For example, the SMS controller may send a command to the first telecommunication device 22 for telling the device 22 to send a text message or to make a phone call.

Device event messages 40 are created by the subsystems 36 when one of the respective functions is executed on one of the telecommunication devices 22, 24. Said differently, the first telecommunication device 22 generates one of the device event messages 40 each time a phone call is made, a text message is sent, etc. Accordingly, each of the device event messages 40 are sent to one of the specific controller modules 38 for executing a predetermined function bound to that specific device event message.

Application event messages 42 are generated by the software application 30 at predetermined time intervals, such as every 10 seconds. The application event messages 42 are sent to all of the controller modules 38, typically simultaneously. The application event messages 42 may be used to perform various functions of any or all of the controller modules 38.

The software application 30 also includes a configuration script 44. The configuration script 44 is in communication with the controller modules 38 for controlling functionality of the software application 30 and the first telecommunication device 22. The configuration script 44 is preferably written in a programming language that may be understood or interpreted by various operating systems, such as but not limited to, both the BlackBerry OS and iOS. A suitable programming language to allow interpretation across multiple operating systems is extensible markup language (XML). XML is widely used in the art for the representation of arbitrary data structures. Utilizing XML allows the software application 30 to be used with various types of telecommunication devices, running different operating systems, without having to significantly change, if at all, the configuration script 44. In other words, the configuration script 44 does not need to be unique for each operating system and/or telecommunication device. It is to be appreciated that other suitable programming languages may also be utilized without deviating from the scope of the present disclosure.

The configuration script 44 comprises a plurality of scriptlets (not separately shown). The scriptlets are typically executed at the start-up of the first telecommunication device 22 or during normal operation of the device 22. The scriptlets are generally structured into a plurality of commands for providing at least one instruction. Each of the commands include a target. The target directs the instruction to one of the controller modules 38 for performing a function. The command typically also includes the instruction and at least one parameter for modifying the instruction. An exemplary structure of the command will now be described. The target and the instruction are separated by a decimal point. The parameters are generally separated by spaces. Each command is separated from one another by a new line. A typical command may be structured as follows:
[target].[instruction] <parameter X> <parameter Y>

The scriptlets are typically associated with a specific event message. The specific event message may be one of the device event messages 40 or one of the application event messages 42. Alternatively, one of the scriptlets may be associated with one of the device event messages 40 and one of the application event messages 42. It is to be appreciated that there is no particular restriction on the target within each of the scriptlets. For example, the SMS controller can be directed to interact with the voice controller, or any other one of the controller modules 38.

Each of the commands may be used to influence a subsequent command. A last in, first out (LIFO) stack may be utilized to pass data from one of the commands to the subsequent command. For example, after one of the commands is executed, a value is created. The value is then sent to a subsequent command as one of the parameters of the subsequent command. A lifecycle of the LIFO stack is typically limited to a duration of event processing, i.e., the length of time required to process the device event messages 40 or the application event messages 42. It is to be appreciated that other methods of interaction between the commands may also be utilized without deviating from the scope of the present disclosure.

The software application 30 further includes a logic block 46 in communication with the configuration script 44. The logic block 46 is typically not in direct communication with the controller modules 38 or the telecommunication device 22. The logic block 46 provides processing functions for the configuration script 44. Specifically, the logic block 46 provides the processing functions for portions of the configuration script 44 that are not directly associated with a specific controller. The configuration script 44 includes control commands which do not affect any of the controller modules 38 or the telecommunication device 22. The control commands are necessary for the configuration script 44 to function properly. As an example, the control command may control the execution flow of the configuration script 44.

The software application 30 still further includes a communications block 48. The communication block enables communication between first telecommunication device 22 and the server computer 32. Specifically, the server computer 32 sends updates and commands to the configuration script 44 via the communications block 48, and receives the notifications or messages from the device 22 via the communications block 48. The communications block 48 typically comprises a plurality of configurable queues and a link for connecting to the server computer 32. The queues store messages destined for the server 32. The messages may include the device event messages 40 and/or the application event messages 42 generated on the first telecommunication device 22. The link is further defined as an http link or an https link. The link attempts to flush the queues to the server at a predetermined time for each of the queues such that each of the queues has a priority. This predetermined time is further defined as a configurable timeout. The queues are substantially similar to one another and typically only differ in the priority in which each of the queues is sent, i.e., emptied, to the server.

The software application 30 also includes a storage component 50. The storage component 50 is typically used to store persistent device memory. Persistent device memory is a term used to describe memory in which the contents thereof are preserved when the device 22 is powered off and which is accessible when the device 22 is powered on. For example, the configuration script 44 is typically stored in the storage component 50. Additionally, if one of the queues cannot be emptied to the server, or if the queue can only be partially emptied, the queue or portion thereof may be saved in the storage component 50. The queue may not be emptied or only be partially emptied if a signal between the device 22 and the network 26, 28 cannot be established, if the signal is too weak to transfer the data within the queue, and/or if the signal is dropped, i.e., becomes disconnected, during transmission of the data from the queue. Also, the controller modules 38 may save data to the storage component 50, especially if that data is needed when the device 22 is powered on.

In one embodiment, the computerized system 20 is utilized for recording transactional and usage data between the first and second telecommunication devices 22, 24. The software application 30 may be loaded onto the first telecommunication device 22 via the OTA technique described above. The software application 30 captures transactional data streams and transmits these transactional data streams as described in greater detail below.

The server computer 32 is in communication with the first telecommunication device 22. The server computer 32 is implemented as an application server 52 and a data store 54. Of course, multiple server computers with one or more application servers and data stores may be implemented without deviating from the scope of the present disclosure.

A monitoring acknowledgement request is sent to the first telecommunication device 22 from the server computer 32 in response to the software application 30 being loaded onto the first telecommunication device 22. This request is typically implemented as a character-based message. The computerized system 20 may require confirmation of receipt of the monitoring acknowledgement request by the first telecommunication device 22 prior to allowing functionality thereon. For example, the request may ask, “do you understand that any use of this device, including all voice conversations and text messages, may be recorded and utilized by others?” The computerized system 20 then requires that a confirmation message be sent back to the server computer 32. For example, the confirmation message may be the word “Yes” or simply the letter “Y”.

The software application 30 being executed on the first telecommunication device 22 streams the transactional data from the first telecommunication device 22 to the server computer 32. The data captured by the software application 30 on the first telecommunication device 22, and collected by the server computer 32, includes, but is not limited to, call records (both inbound and outbound), text messaging data (inbound/outbound transactions as well as message content), and multi-media messaging data (inbound/outbound transactions as well as message content). Typically, most data traffic is from the first telecommunication device 22 to the server computer 32. However, the download of the software application 30 to the first telecommunication device 22 as well as commands to remotely lock and wipe the first telecommunication device 22 will be sent from the server computer 32 to the first telecommunication device 22.

The “call records” may include data representing all or part of an audible conversation between the first telecommunication device 22 and the second telecommunication device. As such, both the first telecommunication device 22 and the server computer 32 include a recording component (not separately numbered) for recording the communications between the first and second telecommunication devices 22, 24.

The application server 52 receives the transmissions of the transactional data from the first telecommunication device 22 and aggregates this transactional data into flat files. The flat files are then collected and pushed to the data store 54 using a mediator 56, also referred to as a mediation bridge. The mediator 56 ensures that all the collected files are backed-up, archived, and distributed to the data store 54 and that the original files on the application server 52 are destroyed.

The data store 54 enriches the transaction records with subscriber profile information that is stored and maintained as master records for each of the subscribers utilizing the telecommunication devices 22, 24. The enriched data sets are then made available to data consumers through an exposed application programming interface (API) layer to facilitate data viewing, interaction with the data sets and also data integrations to third-party applications.

The data store 54 also allows for configuration of multiple compliance policies of which any one or more can be deployed against any line of business, logical group or individual subscriber. The computerized system 20 uses an inheritance model to “inherit” compliance policies (or compliance business rules) and apply these against groups and subscribers, where such groups and subscribers may be assigned multiple compliance policies. This enables advanced configuration of the business rules (both for data recording and data viewing).

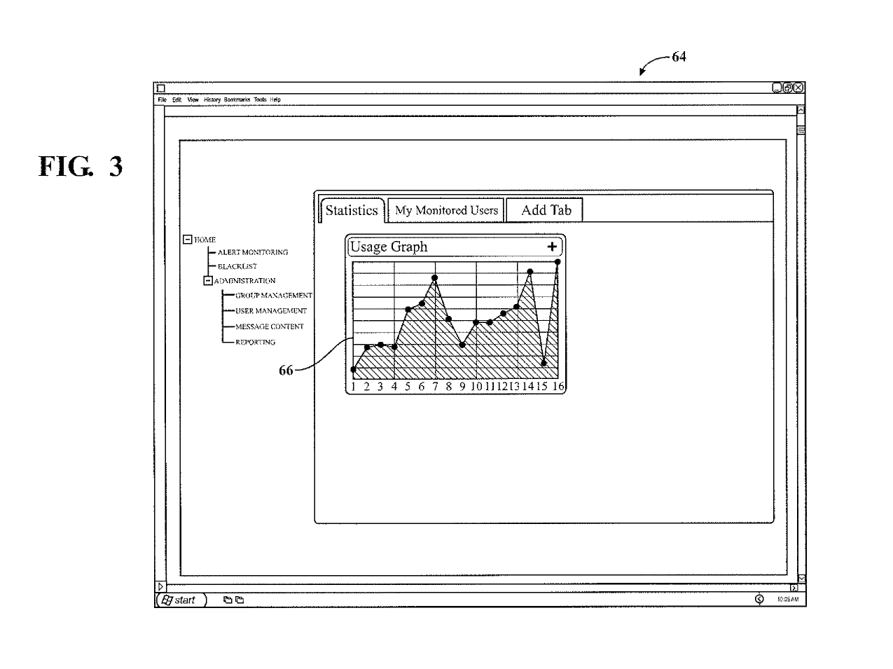

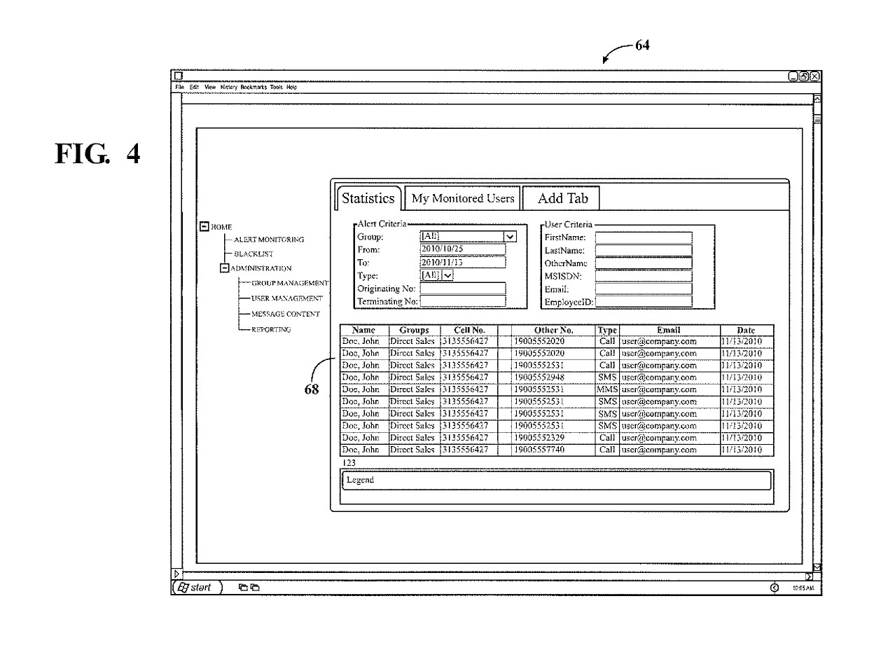

The computerized system 20 includes at least one interface 58 for relaying the content of the data store 54 to a separate storage system 60, to a consumer (not numbered), or other applicable device (not shown). The content may be presented to the consumer in a plurality of forms using any number of techniques known in the art. In one instance, the content may be presented via a computer 62. Specifically, a web browser 64 running on the computer 62, as shown in FIGS. 3 and 4. FIG. 3 shows a graph 66 displaying usage of the first telecommunication device 22. FIG. 4 shows a detailed listing 68 of telephone calls made and text messages exchanged using the first telecommunication device 22.

The computerized system 20 may also store a list of persons and/or organizations to which the first user is not permitted to contact. For example, the list, e.g., a “black list”, may include the phone numbers of business competitors, former employees, etc. An alert may be sent to a third party, e.g., the computer 62, when communication between the first telecommunication device 22 and a person and/or organizations on the list.

Furthermore, the computerized system 20 may provide a convenient display of all communications between the first telecommunication device 22 and second telecommunication device, such as a person or organization on the list. For instance, the system 20 may display a timeline (not shown) of each individual communications which allows the consumer to see exactly what form of communication was utilized along with the content of each communication. In one example, the computerized system 20 may display, on one “screen” of the computer 62, a phone call received on a first day of a month, a text message sent on a second day of a month, an email received on a third day of a month, and a data file transmitted on a fourth day of a month.

Referring again to FIG. 1, the computerized system 20 preferably includes a plurality of firewalls 70 to prevent unauthorized or malicious transfer of data, i.e., “hacking”, from the server computer 32. For example a first firewall 70a is implemented between the first telecommunication device 22 and the application server 52 to prevent access of data from the first telecommunication device 22. Additionally, a second firewall 70b is implemented between the data store 54 and the separate storage system 60 and a third firewall 70c is implemented between the data store 54 and the consumers via the interface 58.

The system disclosed herein may be implemented on one or more suitable computing devices, which generally include applications that may be software applications tangibly embodied as a set of computer-executable instructions on a computer readable medium within the computing device. The computing device may be any one of a number of computing devices as set forth above.

Computing devices generally each include instructions executable by one or more devices such as those listed above. Computer-executable instructions may be compiled or interpreted from computer programs created using a variety of programming languages and/or technologies, including without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable media includes any medium that participates in providing data (e.g., instructions), which may be read by a computing device such as a computer. Such a medium may take many forms, including, but not limited to, non-volatile media, volatile media, and transmission media. Non-volatile media includes, for example, optical or magnetic disks and other persistent memory. Volatile media include dynamic random access memory (DRAM), which typically constitutes a main memory. Common forms of computer-readable media include any medium from which a computer can read.

It is to be understood that the above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claim, along with the full scope of equivalents to which such claims are entitled. It is anticipated and intended that further developments will occur in the arts discussed herein, and that the disclosed systems and methods will be incorporated into such further examples. In sum, it should be understood that the invention is capable of modification and variation and is limited only by the following claims.

The present embodiments have been particular shown and described, which are merely illustrative of the best modes. It should be understood by those skilled in the art that various alternatives to the embodiments described herein may be employed in practicing the claims without departing from the spirit and scope of the invention and that the method and system within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable construction and their ordinary meaning as understood by those skilled in the art unless an explicit indication to the contrary is made herein. In particular, use of the singular articles such as “a”, “the”, “said”, etc. should be read to recite one or more of the indicated elements unless a claim recites an explicit limitation to the contrary.

What is claimed is:

1. A computerized system for controlling the behavior of a telecommunications device, said system comprising:
a server computer in communication with the telecommunications device, said server computer configured to download a software application to the telecommunications device, said software application configured to capture messages and transactional data, and transmit said messages and transactional data to said server computer, said software application including:
a plurality of controller modules in communication with a plurality of subsystems on the telecommunications device, wherein each of the plurality of subsystems manage and execute at least one function of the telecommunications device;
a configuration script in communication with said controller modules, said configuration script being configured to control the functionality of said software application and the telecommunication device; and
a communications block configured to enable communication between the telecommunications device and said server computer.

2. The computerized system of claim 1, wherein said transactional data includes at least one of call records, text messaging data and multi-media messaging data, and said messages include one or more of device event messages and application event messages generated on the telecommunications device.

3. The computerized system of claim 1, wherein said server computer sends updates and commands to said configuration script via said communications block and receives messages from the telecommunications device via said communications block.

4. The computerized system of claim 1, wherein said software application is dynamically configurable.

5. The computerized system of claim 1, wherein said controller modules include one or more of: a voice controller, a data controller, an email controller, a Wi-Fi controller, a SMS controller, a MMS controller, a GPS controller, and a device power controller.

6. The computerized system of claim 1, wherein said configuration script is written in extensible markup language (XML).

7. The computerized system of claim 1, wherein said configuration script includes a plurality of scriptlets, each scriptlet configured to provide at least one instruction to at least one of said controller modules for performing a function.

8. The computerized system of claim 7, wherein each scriptlet includes at least one command for performing said function, said at least one command includes a target, an instruction and at least one parameter for modifying said instruction.

9. The computerized system of claim 1, wherein said communications block includes a plurality of configurable queues and a link for connecting to said server computer.

10. The computerized system of claim 9, wherein said plurality of configurable queues store messages destined for said server computer.

11. The computerized system of claim 10, wherein said messages may include device event messages and/or application event messages generated on the telecommunication device.

12. The computerized system of claim 9, wherein said link attempts to flush said queues to said server computer at a predetermined time for each of said queues such that each of said queues has a priority.

13. The computerized system of claim 1, wherein said software application further includes a logic block configured to provide processing functions for at least a portion of said configuration script.

14. The computerized system of claim 1, wherein said software application further includes a storage component configured to store persistent device memory.

15. The computerized system of claim 1, further comprising an interface configured to transmit content from said server computer to one or more of a remote storage system, a consumer or remote device.

16. The computerized system of claim 15 wherein said server computer is configured to receive and aggregate said transactional data from the telecommunications device into flat files that are transmitted to a data store.

17. A method for controlling the behavior of a telecommunications device, said method comprising:
downloading a software application to the telecommunications device from a server computer, said software application configured to capture messages and transactional data, and transmit said messages and transactional data to said server computer, said software application including:
a plurality of controller modules in communication with a plurality of subsystems on the telecommunications device, wherein each of the plurality of subsystems manage and execute at least one function of the telecommunications device;
a configuration script in communication with said controller modules, said configuration script being configured to control the functionality of said software application and the telecommunication device; and
a communications block configured to enable communication between the telecommunications device and said server computer.

18. The method of claim 17, further including dynamically configuring said software application from said server computer.

19. The method of claim 17, further including sending updates and commands from said server computer to said configuration script via said communications block and receiving messages to said server computer from the telecommunications device via said communications block.

20. The method of claim 17, further including streaming said transactional data from the telecommunications device to said server computer.
